(19) United States
(12) Patent Application Publication
(10) Pub. No.: US 2026/0121187 A1
(43) Pub. Date: Apr. 30, 2026

(54) FIRE-RETARDANT ASSEMBLY AND BATTERY ASSEMBLY COMPRISING THE SAME

(71) Applicant: SK On Co., Ltd., Seoul (KR)

(72) Inventors: Kyu Hyun HAN, Daejeon (KR); Chae Won NA, Daejeon (KR); Yun Joo NOH, Daejeon (KR); Gang U LEE, Daejeon (KR); Won Gab HWANG, Daejeon (KR)

(21) Appl. No.: 19/373,733

(22) Filed: Oct. 30, 2025

(30) Foreign Application Priority Data
Oct. 30, 2024 (KR) 10-2024-0151119

(51) Int. Cl. H01M 50/24; H01M 50/211; H01M 50/293

(52) U.S. Cl. CPC H01M 50/24; H01M 50/211; H01M 50/293; H01M 2220/20

(57) ABSTRACT

The embodiments of the present disclosure relate to a fire-retardant assembly and a battery assembly comprising the same. According to one embodiment of the fire-retardant assembly comprising a fire-retardant member including a fire-retardant material; and an exterior material configured to accommodate the fire-retardant member therein, wherein the fire-retardant material may comprise vermiculite.

### CROSS-REFERENCE TO RELATED PATENT APPLICATION

The present application claims priority under 35 U.S.C. § 119 (a) to Korean patent application number 10-2024-0151119 filed on Oct. 30, 2024, in the Korean Intellectual Property Office, the entire disclosure of which is incorporated by reference herein.

### BACKGROUND OF THE INVENTION

### 1. Field

The present disclosure relates to a fire-retardant assembly and a battery assembly comprising the same. More particularly, it relates to a fire-retardant assembly that is inserted into a battery assembly to improve the thermal stability of the battery assembly, and a battery assembly comprising the same.

### 2. Description of the Related Art

Due to recent fires and explosions that have occurred when lithium rechargeable batteries are used, there has been a growing social concern about the safety of battery use. Based on these social concerns, one of the major development issues in recent lithium rechargeable batteries is to eliminate safety hazards such as fire and explosion due to thermal runaway of the battery cell.

In particular, battery modules and battery packs, which are examples of battery assemblies, contain empty spaces other than the battery cells that are the energy source. If a fire occurs due to an external impact or a problem with the battery cells themselves, the flames can spread to neighboring cells through the empty space, causing significant damage. The risk of such fires can be one of the biggest obstacles to the development of the electric vehicle market, so devising methods to reduce the propagation of fires is constantly being researched.

### SUMMARY OF THE INVENTION

Embodiments of the present disclosure provides a battery assembly comprising a fire-retardant assembly that is capable of preventing or mitigating the escape of hot gases from a battery cell that has undergone thermal runaway, such as one or more battery cells housed within the battery assembly, towards a tap of the battery cell.

Another embodiment of the present disclosure provides a battery assembly comprising a fire-retardant assembly that allows hot gases generated in a battery cell that has experienced thermal runaway to vent in the intended path.

Another embodiment of the present disclosure provides a battery assembly comprising a fire-retardant assembly that can further improve the safety and reliability of the battery assembly by further enhancing its heat resistance or fire resistance.

Another embodiment of the present disclosure provides a battery assembly comprising a fire-retardant assembly that can facilitate placement of the fire-retardant assembly during assembly of the battery assembly.

Another embodiment of the present disclosure provides a battery assembly comprising a fire-retardant assembly that the weight increase of the battery assembly can be minimized by further inserting the fire-retardant assembly into the battery assembly.

Meanwhile, the present disclosure may be widely applied in the fields of green technology, including electric vehicles (EVs), battery charging stations, energy storage systems (ESS), photovoltaics, and wind power, all of which utilize batteries. In addition, the present disclosure may be used in eco-friendly mobility, including electric vehicles and hybrid vehicles, to prevent climate change by reducing air pollution and greenhouse gas emissions.

A fire-retardant assembly according to the present disclosure comprises a fire-retardant member including a fire-retardant material; and an exterior material configured to accommodate the fire-retardant member therein, wherein the fire-retardant material may comprise vermiculite.

According to an embodiment, the fire-retardant member may comprise an expanded vermiculite.

According to an embodiment, the fire-retardant member may comprise a plurality of vermiculite particles.

According to an embodiment, an average particle size of the plurality of vermiculite particles may more than or equal to 2 μm and less than or equal to 5 mm.

According to an embodiment, the exterior material may start to melt at a preset temperature, and the preset temperature may lower than a melting point of the fire-retardant member.

According to an embodiment, a filling rate of the fire-retardant member within the exterior material may from 90% to 99.9% by volume.

According to an embodiment, a weight of the fire-retardant assembly may from 3 g to 5 g.

A battery assembly according to the present disclosure may comprises a plurality of battery cells that are stacked; an accommodating case accommodating the plurality of battery cells; an insertion space formed between the plurality of battery cells and the accommodating case; and a fire-retardant assembly disposed in the insertion space, wherein the fire-retardant assembly comprising: a fire-retardant member comprising a fire-retardant material; and an exterior material configured to accommodate the fire-retardant member therein, wherein the fire-retardant material may comprise a vermiculite.

According to an embodiment, the fire-retardant member may comprise an expanded vermiculite.

According to an embodiment, the fire-retardant member may comprise a plurality of vermiculite particles.

According to an embodiment, an average particle size of the plurality of vermiculite particles may more than or equal to 2 μm and less than or equal to 5 mm.

According to an embodiment, the exterior material may start to melt at a preset temperature, and the preset temperature may lower than a melting point of the fire-retardant member.

According to an embodiment, a filling rate of the fire-retardant member within the exterior material may from 90% to 99.9% by volume.

According to an embodiment, a weight of the fire-retardant assembly may from 3 g to 5 g.

According to an embodiment, the height of the exterior material may greater than a maximum length of one end face of the exterior material in a direction perpendicular to the height of the exterior material.

According to an embodiment, the exterior material may have cylindrical or polyhedral in shape.

According to an embodiment, the battery assembly further comprises a busbar electrically connected to the plurality of battery cells, wherein the insertion space may be located between the busbar and the plurality of battery cells.

According to an embodiment, wherein the insertion space comprises: a first insertion space formed between the plurality of battery cells and a one side of the accommodating case extending along a stacking direction of the plurality of battery cells; and a second insertion space formed between the plurality of battery cells and the other side of the accommodating case facing the one side of the accommodating case;

wherein the fire-retardant assembly may be disposed in at least one of the first insertion space and the second insertion space.

Embodiments of the present disclosure provides a battery assembly comprising a fire-retardant assembly that is capable of preventing or mitigating the escape of hot gases from a battery cell that has undergone thermal runaway, such as one or more battery cells housed within the battery assembly, towards a tap of the battery cell.

Another embodiment of the present disclosure provides a battery assembly comprising a fire-retardant assembly that allows hot gases generated in a battery cell that has experienced thermal runaway to vent in the intended path.

Another embodiment of the present disclosure provides a battery assembly comprising a fire-retardant assembly that can further improve the safety and reliability of the battery assembly by further enhancing its heat resistance or fire resistance.

Another embodiment of the present disclosure provides a battery assembly comprising a fire-retardant assembly that can facilitate placement of the fire-retardant assembly during assembly of the battery assembly.

Another embodiment of the present disclosure provides a battery assembly comprising a fire-retardant assembly that the weight increase of the battery assembly can be minimized by further inserting the fire-retardant assembly into the battery assembly.

Meanwhile, the present disclosure may be widely applied in the fields of green technology, including electric vehicles (EVs), battery charging stations, energy storage systems (ESS), photovoltaics, and wind power, all of which utilize batteries. In addition, the present disclosure may be used in eco-friendly mobility, including electric vehicles and hybrid vehicles, to prevent climate change by reducing air pollution and greenhouse gas emissions.

### BRIEF DESCRIPTION OF THE DRAWINGS

FIG. 1 is a diagram illustrating an example of a fire-retardant assembly in accordance with one embodiment of the present disclosure.

FIG. 2 is a diagram illustrating a one end face of the fire-retardant assembly of FIG. 1.

FIG. 3 is a diagram illustrating another example of a fire-retardant assembly in accordance with one embodiment of the present disclosure.

FIG. 4 is a diagram illustrating an example of a battery assembly in accordance with one embodiment of the present disclosure.

FIG. 5 is a diagram illustrating an example disassembled view of a battery assembly according to one embodiment of the present disclosure.

FIG. 6 is diagram illustrating an example of a battery assembly according to one embodiment of the present disclosure, viewed from above.

FIG. 7 is an enlarged view of S1 of FIG. 6.

FIG. 8 is a perspective view of an example of a fire-retardant assembly accommodated in an insertion space, viewed from above.

FIG. 9 is a cross-sectional view from above of an example of a battery assembly according to one embodiment of the present disclosure.

FIG. 10 is a side view of an example of a battery assembly according to one embodiment of the present disclosure.

FIG. 11 is a diagram illustrating an example of a battery assembly in accordance with another embodiment of the present disclosure.

FIG. 12 is an image depicting a fire-retardant assembly manufactured in accordance with an Example.

FIG. 13 is an image depicting the results of a fire delay performance evaluation using a fire-retardant assembly manufactured in accordance with an Example.

FIG. 14 is an image depicting the results of a fire delay performance evaluation using a fire-retardant assembly manufactured in accordance with a Comparative Example.

### DETAILED DESCRIPTION

The embodiments described in the present disclosure may be modified in various ways, and the technology according to an embodiment is not limited to the embodiments described below. Furthermore, throughout this disclosure, expressions such as “comprise,” “include,” “contain,” or “have” with respect to any components are not intended to exclude the presence of other components unless explicitly stated otherwise, and may include additional elements, materials, or processes not specifically enumerated.

In the present disclosure, equal or uniform may mean equal or uniform to each other within acceptable tolerances unless otherwise specified. For example, equal in composition or property measurements may mean that two objects being compared are identical within a margin of error, not just exactly the same. On the other hand, having the same physical property measurements may mean that the difference in the measurements between the objects is approximately less than 5%, more specifically less than 3%, and more specifically less than 1%.

In the present disclosure, an angle formed by two objects being perpendicular or parallel to each other can include being geometrically perpendicular or parallel, as well as being within a small margin of error.

As used herein, numerical ranges include upper and lower bounds and all values within them, increments logically derived from the shape and width of the range being defined, all doubly bounded values, upper and lower bounds of numerical ranges bounded in different forms, and all possible combinations thereof.

Unless otherwise defined herein, “about” may be considered to be a value within 30%, 25%, 20%, 15%, 10%, or 5% of the stated value.

In the present disclosure, “X-direction,” “Y-direction,” and “Z-direction” may be described with reference to a spatial Cartesian coordinate system defined by mutually orthogonal X, Y, and Z axes. Unless otherwise stated, the Z-direction (or third direction) may refer to a vertical direction, the X-direction (or first direction) may refer to any direction perpendicular to the vertical direction, and the Y-direction (or second direction) may refer to a direction perpendicular to both the X-direction and Z-direction. However, it should be understood that the references to X, Y, and Z directions are for descriptive purposes and may be defined differently depending on the chosen frame of reference.

In the present disclosure, the use of terms such as “first,” “second,” and “third” before components is for the purpose of distinguishing between elements and does not imply any particular order, importance, or hierarchical relationship. For example, an embodiment may be implemented including only a second component without a first component.

In the present disclosure, the term “electrically connected” may refer to any type of connection by which multiple objects are electrically communicable with one another without limitation, and may include both direct connections between the objects or connections mediated by a third object.

A component defined as “ . . . portion” in the present disclosure may refer to a single element or a group of two or more elements that are functionally similar or related, without limitation. Such a group of elements may be composed in any combination of hardware, software, or both.

In the present disclosure, the term “disposed” may refer, without limitation, to any spatial relationship in which one object is placed adjacent to another. Non-limiting examples include: coating one object on another; bonding one object to another with an adhesive; attaching by applying heat, pressure, or both; simply positioning at least a portion of one object in contact with at least a portion of another object within a space; or fixing it in place.

The term “secondary battery” as used in the present disclosure may refer to a battery that generates electrical energy via oxidation and reduction reactions during insertion and extraction of cations such as lithium ions into and from a positive electrode and a negative electrode. Specifically, the term “secondary battery” may refer to any of a lithium cobalt battery, lithium high-nickel battery, lithium iron phosphate battery, lithium-ion battery, lithium polymer battery, lithium-sulfur battery, nickel-metal hydride battery, nickel-cadmium battery, sodium battery, or all-solid-state battery. For example, the term “secondary battery” may refer to a lithium-ion secondary battery, although it is not limited thereto.

The term “battery assembly” as used in the present disclosure may be a general term referring to a battery module or a battery pack. Accordingly, the battery assembly according to the present disclosure may refer to a battery module, or may refer to a battery pack that accommodates a plurality of battery cells without a battery module structure, such as in a cell-to-pack (CTP) configuration.

The term “battery cell” as used in the present disclosure may refer to the basic unit of a secondary battery that includes an electrode assembly, an electrolyte, and an exterior material, and is capable of charging and discharging electrical energy.

Hereinafter, the embodiments of the present disclosure will be described in detail. However, the following description is merely illustrative, and the embodiments of the present disclosure is not limited to the specific embodiments described.

### Fire-Retardant Assembly

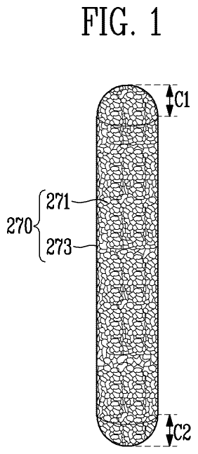

FIG. 1 is a diagram illustrating an example of a fire-retardant assembly in accordance with one embodiment of the present disclosure.

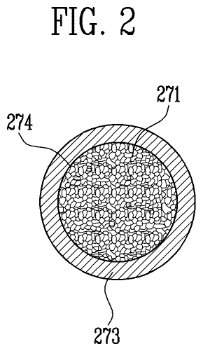

FIG. 2 is a diagram illustrating a one end face of the fire-retardant assembly of FIG. 1.

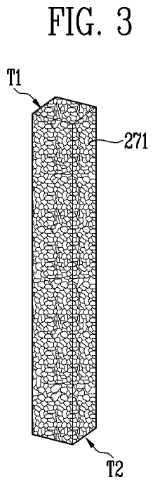

FIG. 3 is a diagram illustrating another example of a fire-retardant assembly in accordance with one embodiment of the present disclosure.

A fire-retardant assembly 270 according to an aspect of the present disclosure comprises a fire-retardant member 271 including a fire-retardant material; and an exterior material 273 configured to accommodate the fire-retardant member 271 therein, wherein the fire-retardant material may comprise vermiculite.

In one embodiment, the fire-retardant member 271 may comprise a fire-retardant material. In one embodiment, the fire-retardant member 271 may comprise vermiculite, i.e., in one embodiment, the fire-retardant material may comprise vermiculite.

Vermiculite is a type of silicate hydrate, a mineral belonging to the monoclinic system with a mica-like crystal structure, and is a structurally three-layered mica-based mineral that contains about 8% to 16% of three types of water: hygroscopic water, intermediate water, and crystalline water based on its total weight. When vermiculite is heated to a temperature of 800° C. to 1,100° C., the water between the layers turns into water vapor and expands rapidly. Upon heating, vermiculite can expand six to thirty times by delamination to become expanded vermiculite or porous vermiculite, which are porous crystals.

In one embodiment, the fire-retardant member 271 may comprise expanded vermiculite, i.e., the fire-retardant material may comprise expanded vermiculite. The expanded vermiculite may refer to expanded vermiculite formed by heating said vermiculite as described above.

In one embodiment, the fire-retardant material included in the fire-retardant member 271 may comprise only vermiculite. In a specific embodiment, the fire-retardant material included in the fire-retardant member 271 may comprise only expanded vermiculite.

In another embodiment, the fire-retardant member 271 may further comprise a fire-retardant inorganic compound in addition to the above vermiculite. The inorganic compounds may include, for example, Alum (K₂SO₄·Al₂(SO₄)₃·24H₂O), Borax (Na₂B₄O₇·10H₂O), Lime Water (Ca(OH)₂ aqueous solution), Quicklime (CaO), a white emulsion made by mixing milk of lime with water, Slaked Lime, Washing Soda (Na₂CO₃·10H₂O), Apatite (Ca₅(PO₄)·3OH), Baking Powder (a mixture of NaHCO₃ and salts of tartaric acid), Baking Soda (NaHCO₃), Sodium Thiosulfate Pentahydrate (Na₂S₂O₃·5H₂O), Silica (or Silicon Dioxide SiO₂), Alumina (or aluminum oxide (Al₂O₃), calcium oxide (CaO), calcium sulfate (CaSO₄), calcium chloride (CaCl₂)), sodium carbonate (Na₂CO₃), potassium chloride (KCl), magnesium oxide (MgO), zirconium oxide (ZrO₂), chromium oxide (Cr₂O₃), aluminum hydroxide (Al(OH₃)), antimony trioxide (Sb₂O₃), antimony pentoxide (Sb₂O₅), magnesium hydroxide (Mg(OH₂)), and any one compound or mixture thereof selected from the group consisting of zinc borate compounds, phosphorus compounds, nitrogenous guanidine compounds, or molybdenum compounds.

In another embodiment, the fire-retardant member 271 may further comprise a fire-retardant polymer in addition to the vermiculite.

In one embodiment, the flame-retardant polymer may mean a polymer having a rating of V-0 in the UL (Underwriter's Laboratory) 94V test (Vertical Burning Test), which is a fire retardancy specification for polymeric materials.

In one embodiment, the flame-retardant polymers may include phosphorus-based, halogen-based, and inorganic-based polymer, preferably, in the case of phosphorus-based fire-retardant materials, phosphate compounds, phosphonate compounds, phosphinate compounds, phosphine oxide compounds, phosphazene compounds, and metal salts thereof. They can be used alone or in a mixture of two or more.

Other specific embodiments include diphenyl phosphate, diaryl phosphate, triphenyl phosphate, tricresyl phosphate, triazylenyl phosphate, tri(2,6-dimethylphenyl)phosphate, tri(2,4,6-trimethylphenyl)phosphate, tri(2,4-ditertiarybutylphenyl)phosphate, tri(2,6-dimethylphenyl)phosphate, bisphenol-A bis(diphenyl phosphate), resorcinol bis(diphenylphosphate), resorcinol bis[bis(2,6-dimethylphenyl)phosphate], resorcinol bis[bis(2,4-ditertiarybutylphenyl)phosphate], hydroquinone bis[bis(2,6-dimethylphenyl)phosphate], hydroquinone bis[bis(2,4-ditertiarybutylphenyl)phosphate], and oligomeric phosphoric acid ester-based compounds, including, but not limited to. They may be applied singly or in the form of a mixture of two or more.

In one embodiment, the fire-retardant member 271 may comprise a plurality of vermiculite particles.

In one embodiment, an average particle size of the plurality of vermiculite particles may more than or equal to 2 μm and less than or equal to 5 mm.

In one embodiment, the plurality of vermiculite particles may have an average particle size of 5 mm or less. The average particle size may mean the average value of the maximum value of the distance between any two points in three-dimensional space of the individual vermiculite particles. However, it is not necessarily limited to this, and the size may also mean the average value of the average of the sizes of individual vermiculite particles measured in multiple directions.

In one embodiment, the plurality of vermiculite particles may have an average particle size of 2 μm or more. The meaning of size herein is the same as described above.

If the average particle size of the plurality of vermiculite particles is less than the above numerical range, the particles may escape into spaces other than the insertion space 288, such as the space between the accommodating case 210 and the busbar assembly 150 within the battery assembly 200, which may degrade battery performance, and if the average particle size of the plurality of vermiculite particles is greater than the above numerical range, the particles may not be densely packed within the exterior material 273, which may degrade fire and thermal performance in thermal runaway situations.

In one embodiment, the fire-retardant assembly 270 may include an exterior material 273 that includes the fire-retardant member 271 on its interior.

Referring to FIGS. 1 to 3, in one embodiment, the exterior material 273 may allow the fire-retardant assembly 270 to maintain a constant shape regardless of the shape of the fire-retardant member 271. Even when the fire-retardant member 271 is in a liquid state, the exterior material 273 may allow the fire-retardant assembly 270 to maintain a predetermined three-dimensional shape.

Accordingly, referring to FIG. 2, the exterior material 273 may further comprise a fire-retardant space 274 formed by the exterior material 273 to receive the fire-retardant member 271.

In one embodiment, the exterior material 273 may start to melt at a preset temperature, and the preset temperature may lower than a melting point of the fire-retardant member 271. That is, the exterior material 273 may be formed of a material that accommodates the fire-retardant member 271 but melts above an allowable temperature.

In one embodiment, the fire-retardant member 271 may comprise vermiculite. Given that vermiculite has a melting point of approximately 1,315° C., the preset temperature may be at least lower than 1,315° C. However, in specific embodiments, the preset temperature may be lower than an ignition point of the battery cell 110.

In one embodiment, the exterior material 273 may be formed of a heat-resistant (fire-retardant or flame-retardant) material that does not melt until the temperature is reached. According to an exemplary embodiment, the exterior material 273 may be formed from a polymer such as Polypropylene (PP), Polyethylene (PE), Rubber, Cellulose, or Resin. Alternatively, the exterior material 273 may be formed of a polymer in the form of foam.

In one embodiment, the ignition point of the battery cell 110 may be above the predetermined temperature and below the melting point of the vermiculite.

Thus, when thermal runaway begins within the battery assembly 200, the exterior material 273 may begin to melt, but the fire-retardant member 271, specifically vermiculite, may not melt or burn.

Thus, the effect of having the outer surface of the fire-retardant assembly 270 coated with the exterior material 273 can be achieved, which can increase the heat resistance (fire-retardant or flame-retardant) of the fire-retardant assembly 270, as well as add or improve moisture resistance or moisture proofing.

In one embodiment, the fire-retardant member 271 received in the exterior material 273, specifically the plurality of vermiculite particles received in the exterior material 273, may be inserted into the fire-retardant space 274 formed by the exterior material 273 and may be free to move, i.e., may not be fixed or bonded to any other structure or component of the battery assembly 200.

In one embodiment, the fire-retardant member 271 may be positioned in the fire-retardant space 274 without any constraint. In a specific embodiment, the plurality of vermiculite particles may be positioned in the fire-retardant space 274 so that they are only in contact with each other, without being otherwise constrained.

Accordingly, the fire-retardant assembly 270 may comprise a plurality of voids (not shown) formed between the fire-retardant members 271 disposed without any constraint and, in a specific embodiment, between the intercontacting regions of the plurality of vermiculite particles disposed only in contact with each other without any constraint. When the exterior material 273 is melted, exposing the fire-retardant member 271, specifically the plurality of vermiculite particles located in the fire-retardant space 274, to the insertion space 288, the plurality of voids may serve to retard heat propagation and disperse the flame in various paths other than straight lines.

In addition, in high temperature, high humidity environments such as those created during thermal runaway, the plurality of pores may additionally act as electrical insulators or thermal insulators.

In one embodiment, a filling rate of the fire-retardant member within the exterior material may from 90% to 99.9% by volume. In more specific embodiments, the filling rate may be 91% or more, 92% or more, 93% or more, 94% or more, 95% or more, 96% or more, 97% or more, 98% or more, 98.5% or more, or 99% or more.

The filling rate may refer to a volumetric filling rate of the fire-retardant member 271 within the exterior material 273.

In specific embodiments, the filling rate of the fire-retardant member 271 may refer to a volumetric filling rate of the fire-retardant member 271 relative to a volume of the fire-retardant space 274.

By employing vermiculite, and more specifically expanded vermiculite, as the fire-retardant material received within the exterior material 273 in one embodiment of the present disclosure, the filling rate within the exterior material 273 may be improved compared to conventionally used fire-retardant materials such as bead-type particles due to material properties.

On the other hand, by having a filling rate in the numerical range as described above, the fire-retardant material can be more densely arranged within the same space, further enhancing the heat resistance (fire-retardant or flame-retardant) of the fire-retardant assembly 270.

In one embodiment, a weight of the fire-retardant assembly may from 3 g to 5 g. In specific embodiments, the weight may be 3.1 g or more, 3.2 g or more, 3.3 g or more, or 3.5 g or more, 4.8 g or less, or 4.6 g or less.

By employing vermiculite, and more specifically expanded vermiculite, as the fire-retardant material in one embodiment of the present disclosure, the weight of the fire-retardant assembly 270 may be reduced compared to members employing conventionally used fire-retardant materials due to the material properties, thereby improving heat resistance while minimizing the weight increase associated with employing the fire-retardant assembly 270, thereby improving the energy efficiency per weight while ensuring the safety of the battery assembly 200.

In one embodiment, the exterior material 273 may be in the shape of a pillar extending along a preset direction. Of note, as will be discussed later, the preset direction may mean the same direction as the height direction of the accommodating case 210.

In one embodiment, a height of the exterior material 273 may greater than a maximum length of one end face of the exterior material 273 in a direction perpendicular to the height of the exterior material 273. This configuration allows the fire-retardant assembly 270 to be properly inserted into the insertion space 288, details of which will be described later.

In one embodiment, a maximum length of the cross-section may be 8 mm to 20 mm. In a specific embodiment, the maximum length of the cross-section may be 9 mm or more, or 10 mm or more, or 19 mm or less, 18 mm or less, 17 mm or less, 16 mm or less, or 15 mm or less.

In one embodiment, the height may be 80 mm to 120 mm. In specific embodiments, the height may be 83 mm or more, or 85 mm or more, or 110 mm or less, 105 mm or less, or 100 mm or less.

Referring again to FIG. 1, in one embodiment, the exterior material 273 may be cylindrical in shape. Thus, the fire-retardant assembly 270 may be formed entirely in a cylinder shape. Meanwhile, the height of the shaped fire-retardant assembly 270 may be greater than the diameter of one side of the fire-retardant assembly 270.

Referring again to FIG. 1, the two ends of the fire-retardant assembly 270 may be tapered. This is to facilitate insertion of the fire-retardant assembly 270 into the insertion space 288 to be described later, i.e., the regions C1, C2 including the two ends may be tapered such that when the fire-retardant assembly 270 is inserted into the insertion space 288 to be described later, the fire-retardant assembly 270 can be guided into the insertion space 288.

Furthermore, the shape of the regions C1, C2 comprising the two ends of the fire-retardant assembly 270 may be symmetrical. This enables the fire-retardant assembly 270 to be inserted into the insertion space 288 to be described later without distinguishing between the top and bottom of the fire-retardant assembly 270, thereby increasing the ease of assembly of the battery assembly 200 to be described later.

In other words, the regions C1, C2 including both ends of the fire-retardant assembly 270 may have the same shape.

FIG. 1 is only a schematic representation of the fire-retardant assembly 270, and more specifically, as shown in FIG. 2, the fire-retardant assembly 270 may include a fire-retardant member 271 comprising a fire-retardant material and an exterior material 273 receiving the fire-retardant member 271 therein, and may further include a fire-retardant space 274 formed by the exterior material 273 to receive the fire-retardant member 271 as described above.

Referring again to FIG. 3, in one embodiment, the exterior material 273 may be polyhedral in shape. In a specific embodiment, the exterior material 273 may be cuboidal in shape. Thus, the fire-retardant assembly 270 as a whole may be formed in a polyhedral shape, more specifically a cuboidal shape.

In FIG. 3, the two ends T1, T2 of the cuboidal fire-retardant assembly 270 are shown in a planar shape, but may alternatively comprise at least some curved surfaces.

Referring to FIGS. 1 to 3, the fire-retardant member 271 is shown as having filled all of the fire-retardant space 274 along the height direction of the exterior material 273. However, it is also possible that the fire-retardant member 271 fills the fire-retardant space 274 with a different figure.

In one embodiment, the fire-retardant material may comprise vermiculite, in particular expanded vermiculite as described above. Expanded vermiculite has excellent thermal resistance properties and, due to its expansion characteristics, is lighter in weight than conventional fire-retardant materials. Accordingly, these properties may provide a tighter pathway for heat or flame in the event of a thermal runaway situation within the battery assembly 200, and the resulting weight gain within the battery assembly 200 may be more limited than conventionally, even when sufficiently included within the battery assembly 200 to effectively provide fire resistance.

In view of the function and form of the fire-retardant assembly 270, the fire-retardant assembly 270 may be referred to as a Fire-Retardant Capsule or Fire-Mitigation Capsule or FR (or FM) capsule.

### Battery Assembly

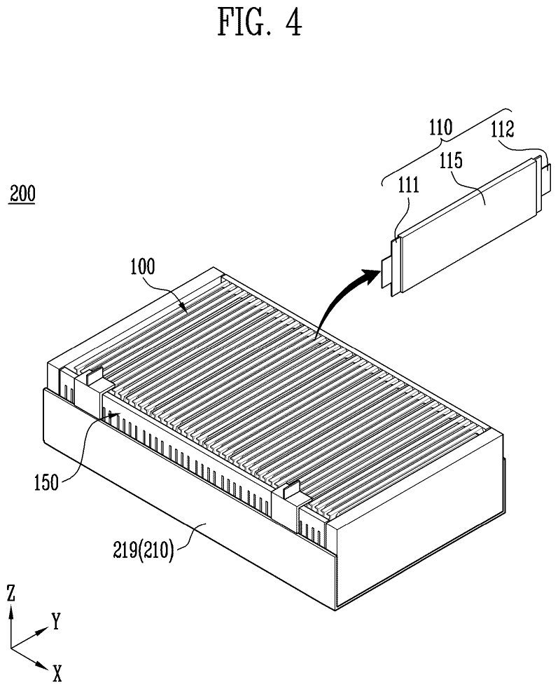

FIG. 4 is a diagram illustrating an example of a battery assembly in accordance with one embodiment of the present disclosure.

A battery assembly 200 according to an aspect of the present disclosure may comprise a plurality of battery cells 110 that are stacked; an accommodating case 210 accommodating the plurality of battery cells 110; an insertion space 288 formed between the plurality of battery cells 110 and the accommodating case 210; and a fire-retardant assembly 270 disposed in the insertion space 288, wherein the fire-retardant assembly 270 comprising: a fire-retardant member 271 comprising a fire-retardant material; and an exterior material 273 configured to accommodate the fire-retardant member 271 therein, wherein the fire-retardant material may comprise a vermiculite.

In one embodiment, the fire-retardant member 271 may comprise expanded vermiculite.

In one embodiment, the fire-retardant member 271 may comprise a plurality of vermiculite particles.

In one embodiment, an average particle size of the plurality of vermiculite particles may more than or equal to 2 μm and less than or equal to 5 mm.

In one embodiment, the exterior material 273 may start to melt at a preset temperature, and the preset temperature may lower than a melting point of the fire-retardant member 271.

In one embodiment, a filling rate of the fire-retardant member within the exterior material may from 90% to 99.9% by volume.

In one embodiment, a weight of the fire-retardant assembly may from 3 g to 5 g.

In one embodiment, the exterior material 273 may be in the shape of a pillar extending along a preset direction. Of note, as will be described later, the preset direction may mean the same direction as the height direction of the accommodating case 210.

In one embodiment, a height of the exterior material 273 may greater than a maximum length of one end face of the exterior material 273 in a direction perpendicular to the height of the exterior material 273. This configuration allows the fire-retardant assembly 270 to be properly inserted into the insertion space 288, details of which will be described later.

In one embodiment, the exterior material 273 may have cylindrical or polyhedral in shape.

Referring further to FIGS. 1 through 3, the foregoing description of the fire-retardant assembly 270 may be applied herein without limitation.

Referring to FIG. 4, the plurality of battery cells 110 may be stacked along a predetermined stacking direction. Further, the battery assembly 200 may include the plurality of battery cells 110 and an accommodating case 210 for receiving the plurality of battery cells 110.

In one embodiment, each of the plurality of battery cells 110 may include a main body portion 115 that produces or stores electrical energy and lead tabs 111, 112 that protrude from the main body portion 115 to the outside of the main body portion 115. The main body portion 115 may include an electrode assembly (not shown) that is electrically connected to the lead tabs 111, 112 and that produces and stores electrical energy internally.

In an exemplary embodiment, the electrode assembly (not shown) may comprise a positive electrode and a negative electrode.

According to an exemplary embodiment, the positive electrode may comprise a positive electrode current collector and a positive electrode active material applied to at least one surface of the positive electrode current collector.

According to an exemplary embodiment, the negative electrode may comprise a negative electrode current collector and a negative electrode active material applied to at least one side of the negative electrode current collector.

According to an exemplary embodiment, each of the battery cells 110 may further comprise a separator to prevent an electrical short between the negative electrode and positive electrode and to allow the flow of ions to occur. The separator may comprise, for example, a porous polymeric film or a porous nonwoven fabric.

Thus, according to such embodiments, the electrode assembly (not shown) may have a stacked structure with the negative electrode, separator and positive electrode stacked along a predetermined stacking direction. The negative electrode, separator, and positive electrode may be stacked in a stacking, stack-folding, or Z-stacking.

According to an exemplary embodiment, each of the battery cells 110 may include an electrolyte solution for immersing the electrode assemblies (not shown). The electrolyte may be a non-aqueous electrolyte. The electrolyte may comprise a lithium salt and an organic solvent, and may further comprise additives as desired.

According to another exemplary embodiment, each of the battery cells 110 may further comprise a solid electrolyte layer comprising electrolyte in solid form. Thus, according to such an embodiment, the electrode assembly (not shown) may have a stacked structure with the negative electrode, the solid electrolyte layer, and the positive electrode stacked along a predetermined stacking direction.

According to an exemplary embodiment, referring to FIG. 4, the main body portion 115 may be in the form of a pouch sealed with a film-like outer material, i.e., the battery cell 110 may be a pouch-type battery cell. However, this is exemplary and the battery cell 110 may also be an angular or cylindrical battery cell, as shown in FIG. 4.

According to an exemplary embodiment, the lead tabs 111, 112 may comprise a first lead tab 111 and a second lead tab 112 protruding from two sides of the main body portion 115 in a direction away from the main body portion 115. In one example, the lead tab portions 111, 112 may have both tabs on one side.

Further, the accommodating case 210 may be configured to protect the plurality of battery cells 110 from external shock, such as vibration. The accommodating case 210 may comprise an accommodating body 219 that forms part of an accommodating space 280 that houses the plurality of battery cells 110, as will be described later.

In one embodiment, the insertion space 288 may be formed between the plurality of battery cells 110 and the accommodating case 210. Further details of the insertion space 288 will be described later.

In one embodiment, the battery assembly 200 further comprises a busbar 170 electrically connected to the plurality of battery cells 110, and the insertion space 288 may be located between the busbar 170 and the plurality of battery cells 110. Further details of this will be described later.

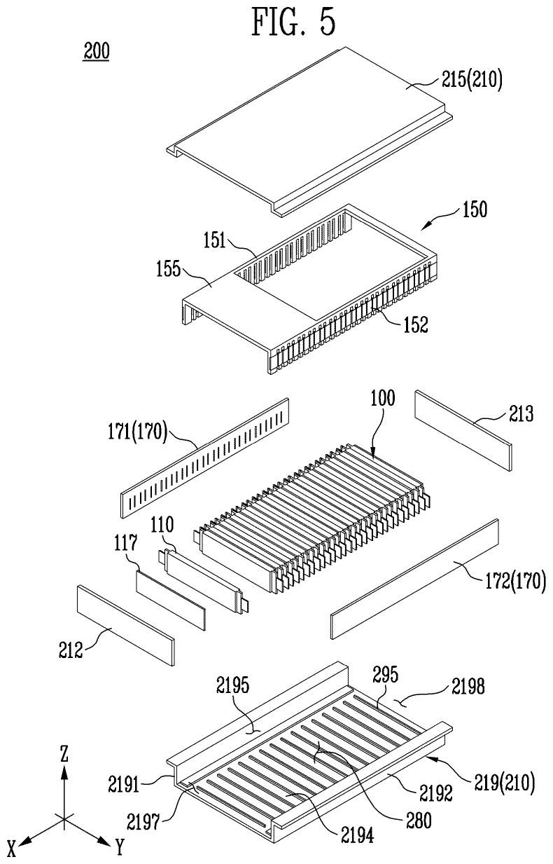

FIG. 5 is a diagram illustrating an example disassembled view of a battery assembly according to one embodiment of the present disclosure.

Referring to FIG. 5, in an exemplary embodiment, the accommodating case 210 may include an accommodating body 219 forming part of an accommodating space 280 housing the plurality of battery cells 110, and an accommodating cover 215 coupled to the accommodating body 219 to form the accommodating space 280 together.

Inside the accommodating body 219, the plurality of battery cells 110 may be positioned in a nested manner along a predetermined stacking direction (e.g., X-direction).

More specifically, the accommodating case 210 may further comprise the accommodating body 219 that includes an apertured top surface 2195, the apertured top surface 2195 receiving the plurality of battery cells 110, and the accommodating cover 215 coupled to the accommodating body 219 to close the apertured top surface 2195.

Thus, the accommodating cover 215 may be coupled to the accommodating body 219 to form the top surface of the accommodating space 280 or the top surface of the accommodating case 210. In other words, the accommodating cover 211 may be coupled to the accommodating body 219 to close the apertured top surface 2195, and together with the accommodating body 219 may form the accommodating space 280.

The accommodating space 280 may comprise a space formed on the interior of the accommodating body 219 to receive the battery cell stack 100. Further, the accommodating space 280 may further comprise an insertion space 288 to be described later.

The accommodating body 219 may be channel-shaped or U-shaped with an open top. Referring to FIG. 5, two of the body sides 2197, 2198 of the accommodating body 219 that face each other along the X-direction may also be open.

That is, the accommodating body 219 may comprise a body bottom face 2194 forming the bottom face of the accommodating space 280, and body sides 2191, 2192 extending toward the accommodating cover 211 from corners (not shown) of the body bottom face 2194 that are side-by-side along the stacking direction. The free ends of the body sides 2191, 2192 may be bent to form a flange (not shown). This may facilitate engagement with the accommodating cover 211.

Referring to FIGS. 4 and 5, the height of the accommodating body 219 may be less than the height of the plurality of battery cells 110. However, this is only an example, and the height of the accommodating body 219 may be greater than or equal to the height of the plurality of battery cells 110.

The battery cell stack 100 may further comprise a cushioning member 117 positioned between the plurality of battery cells 110 or a thermal barrier member 119 to be described later. The cushioning member 117 may be located between each of the battery cells 110.

The thermal barrier members 119 may act as a thermal barrier to prevent flame or heat from propagating from one battery cell 110 to another neighboring battery cell 110 in the event of a thermal explosion of one battery cell 110.

The battery cell stack 100 may comprise at least one of the cushioning members 117. Similarly, the battery cell stack 100 may include at least one or more of the thermal barrier members 119. The cushioning member 117 and the thermal barrier member 119 may be formed into a single member to perform both a thermal barrier and a cushioning function.

To this end, the thermal barrier member 119 may also be formed as a multilayer structure along the stacking direction of the plurality of battery cells 110, i.e., one layer of the multilayer structure may be formed of a flame-retardant material (or a fire-retardant material). In addition, another layer of the multilayer structure may play a role in reducing the pressure on the other battery cells 110 in the event of swelling of the battery cells 110.

Referring now to FIG. 5, the battery assembly 200 may further comprise endplates 212, 213 at both ends of the battery cell stack 100 along the stacking direction. The endplates 212, 213 may be provided at both ends of the battery cell stack 100, or may be formed by connecting to both body sides 2197, 2198 of the accommodating body 219.

The endplates 212, 213 may be configured to prevent both sides of the battery cell stack 100 from being exposed to the outside.

In one aspect, the battery assembly 200 may include a busbar 170 electrically connected to the plurality of battery cells 110 as described above. Further, the battery assembly 200 may further include busbar frame 151, 152, 155 supporting the busbar 170 and the plurality of battery cells 110 as described above. The busbar 170 and the busbar frame 151, 152, 155 may collectively be referred to as a busbar assembly 150, i.e., the busbar assembly 150 may include a busbar 170 electrically connected to the plurality of battery cells 110.

The busbar frame 151, 152, 155 may be electrically connected to the outside to store (or charge) electrical energy in the plurality of battery cells 110, or to supply (or discharge) electrical energy stored in the plurality of battery cells 110 to the outside.

The busbar assembly 150 may include a first busbar frame 151 and a second busbar frame 152 spaced between the plurality of battery cells 110 and extending along a stacking direction of the plurality of battery cells 110.

Further, the busbar assembly 150 may further comprise a support frame 155 located on one side of the busbar assembly 150 connecting the first busbar frame 151 and the second busbar frame 152.

The support frame 155 may serve to support and prevent deformation of the first busbar frame 151 and the second busbar frame 152. Further, a portion of the electrical apparatus for sensing and controlling the plurality of battery cells 110 may be disposed on the support frame 155.

The connections of the busbar 170 and lead tabs 111, 112 are described below. In one embodiment, each of the plurality of battery cells 110 comprises: a main body portion 115 housing an electrode assembly (not shown); and lead tabs 111, 112 at least partially located on an outer side of the main body portion 115 and electrically connected to the electrode assembly (not shown); wherein the busbar 170 is electrically connected with the lead-tabs 111, 112, and wherein the insertion space 288 may be divided into a plurality of regions by the lead tabs 111, 112.

In one embodiment, the busbar 170 may be electrically connected with the lead tabs 111, 112.

FIGS. 4 and 5 illustrate a case where the lead tabs 111, 112 are located on opposite sides of the main body portion 115, respectively. In this case, the lead tabs 111, 112 may be located on either side of the main body portion 115 and electrically connected to the lead tabs 111, 112.

Alternatively, if the lead tabs 111, 112 are located on one side of the main body portion 115 and face in the same direction, the busbar frame 151, 152 may be located on one side of the main body portion 115, such as on a top side of the main body portion 115, and electrically connected to the lead tabs 111, 112.

Referring again to FIG. 5, the shape of the busbar assembly 150 may be tunnel-shaped. Further, the length of the first busbar frame 151 and the second busbar frame 152 along the stacking direction may be longer than the length of the support frame 155.

In other words, the support frame 155 may be connected with the first busbar frame 151 and the second busbar frame 152 to cover the top of the plurality of battery cells 110. In other words, the support frame 155 may cover all of the top of the plurality of battery cells 110, rather than only a portion of the top of the plurality of battery cells 110.

Referring to FIG. 5, the busbar 170 may include a first busbar 171 supported by the first busbar frame 151 and electrically coupled to the first lead tab 111, and a second busbar 172 supported by the second busbar frame 152 and electrically coupled to the second lead tab 112.

The first busbar 171 and the second busbar 172 may be positioned in a direction away from the plurality of battery cells 110 than the first busbar frame 151 and the second busbar frame 152, respectively, i.e., closer to the body sides 2191, 2192 than the first busbar frame 151 and the second busbar frame 152. Accordingly, the first lead tab 111 and the second lead tab 112 may be inserted into slit holes (not shown) formed in the first busbar frame 151 and the second busbar frame 152, respectively, to electrically connect with the first busbar 171 and the second busbar 172. However, this is only an example, and the first lead tab 111 and the second lead tab 112 may be electrically connected to the first busbar 171 and the second busbar 172, respectively, in other methods as well.

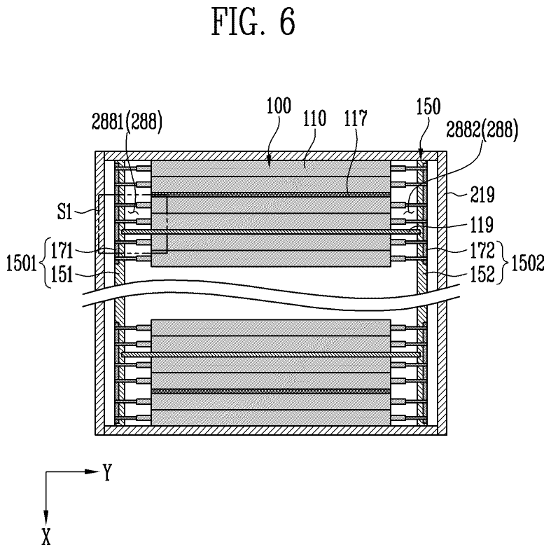

FIG. 6 is diagram illustrating an example of a battery assembly according to one embodiment of the present disclosure, viewed from above.

Referring to FIG. 6, the busbar assembly 150 may include a first busbar 171 electrically connected to the first lead tab 111 and a first busbar frame 151 supporting the first busbar 171. The first busbar 171 and the first busbar frame 151 may collectively be referred to as a first busbar assembly 1501, i.e., the first busbar assembly 1501 may be electrically connected to the first lead tab 111 and may serve to support the battery cell stack 100.

The busbar assembly 150 may further comprise a second busbar 172 electrically connected to the second lead tab 112 and a second busbar frame 152 supporting the second busbar 172. The second busbar 172 and the second busbar frame 152 may collectively be referred to as a second busbar assembly 1502, i.e., the second busbar assembly 1502 may be electrically connected to the second lead tab 112 and may serve to support the battery cell stack 100 in conjunction with the first busbar assembly 1501.

Referring to FIG. 6, the cushioning member 117 may be positioned between the plurality of battery cells 110. The cushioning members 117 may also be provided between each of the plurality of battery cells 110.

Referring to FIGS. 4 to 6, a length of the cushioning member 117 along a direction from the first busbar frame 151 toward the second busbar frame 152 is shown to be less than or equal to a length of the main body portion 115, but is not limited thereto.

Referring to FIG. 6, the thermal barrier member 119 may be located between the plurality of battery cells 110. The thermal barrier member 119 may also be provided between each of the plurality of battery cells 110.

On the other hand, along a direction from the first busbar frame 151 towards the second busbar frame 152, the length of the thermal barrier member 119 may be longer than the length of the main body portion 115. More specifically, the thermal barrier member 119 may contact the first busbar assembly 1501 and the second busbar assembly 1502. This allows the thermal barrier member 119 to block or delay the propagation of heat or flame to other locations in the event of thermal runaway of any of the battery cells 110.

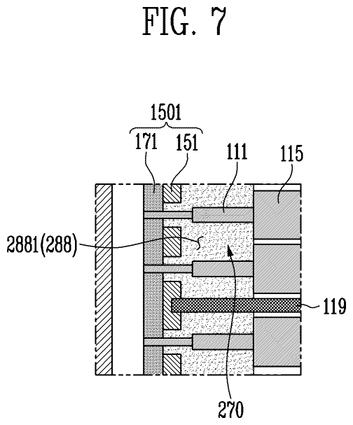

FIG. 7 is an enlarged view of S1 of FIG. 6.

Referring to FIGS. 6 and 7, an empty space may be formed between the plurality of battery cells 110 and the busbar assembly 150 due to spatial connections for electrical connection of the lead tabs 111, 112 to the busbar assembly 150 within the battery assembly 200, more specifically within the accommodating case 210. The empty space may be referred to as the insertion space 288.

That is, a portion of the accommodating space 280 formed inside the accommodating case 210 may be a space for accommodating the plurality of battery cells 110, and another portion of the accommodating space 280 may be a space for the insertion space 288.

Specifically, the insertion space 288 is a space formed by each of the main body portion 115, the respective lead tabs 111, 112, and the busbar 170. Under normal circumstances, when thermal runaway and/or off-gassing occurs in any one of the plurality of battery cells 110, high temperatures of heat and/or flame may propagate to other neighboring battery cells 110 via the insertion space 288. In order to prevent such heat propagation, it is necessary to block the propagation path by filling or sealing the insertion space 288 with a fire-retardant material.

To this end, the battery assembly 200 according to the present disclosure may comprise a fire-retardant assembly 270 inserted and positioned in the insertion space 288.

In one aspect, the S1 portion may be a portion of the insertion space 288. As described above at, the battery assembly 200 may further comprise an insertion space 288 formed between the battery cell stack 100 and the busbar assembly 150 or between the plurality of battery cells 110 and the busbar 170.

In one embodiment, wherein the insertion space 288 comprises: a first insertion space 2881 formed between the plurality of battery cells 110 and a one side of the accommodating case 210 extending along a stacking direction of the plurality of battery cells 110; a second insertion space 2882 formed between the plurality of battery cells 110 and the other side of the accommodating case 210 facing the one side of the accommodating case 210; wherein the fire-retardant assembly 270 may be disposed in at least one of the first insertion space 2881 and the second insertion space 2882.

Referring again to FIGS. 6 and 7, the battery assembly 200 may include first insertion space 2881 and second insertion space 2882 between a first side of each main body portion 115 of the plurality of battery cells 110 and the first busbar 171, and between a second side of each main body portion 115 of the plurality of battery cells 110 and the second busbar 172, respectively.

Further, the fire-retardant assembly 270 may be located in at least one of the first insertion space 2881 or the second insertion space 2882. In FIG. 7, the fire-retardant assembly 270 is located in the insertion space 288, but only its location is shown to emphasize that it is located in the insertion space 288, and the shape of the fire-retardant assembly 270 is not specifically shown in this figure.

More specifically, the S1 portion of FIG. 7 illustrates a portion of the first insertion space 2881. One side of the main body portion 115 may be a side on which the first lead tab 111 is located, and other side of the main body portion 115 may be a side on which the second lead tab 112 is located.

Meanwhile, the first insertion space 2881 may be spatially separated by the first lead tab 111. Further, the second insertion space 2882 may be spaced apart by the second lead tab 112. However, when the battery cell stack 100 is received in the accommodating body 219, the length of the first lead tab 111 and the second lead tab 112 along the height direction of the accommodating case 210 or the accommodating body 219 is less than the height of the battery cell 110, so that each of the first insertion space 2881 and the second insertion space 2882 may be connected.

Furthermore, the first insertion space 2881 and the second insertion space 2882 may be interconnected through the space between the plurality of battery cells 110 and the accommodating cover 215. Thus, the first insertion space 2881 and the second insertion space 2882 may not be separate and isolated from each other, but may be interconnectable.

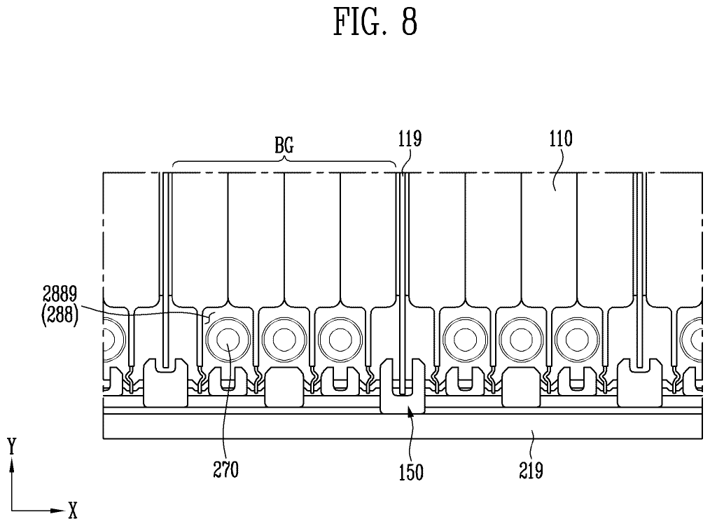

FIG. 8 is a perspective view of an example of a fire-retardant assembly accommodated in an insertion space, viewed from above.

The battery assembly 200 may have an insertion space 288 formed between the plurality of battery cells 110 and the busbar assembly 150 (or the busbar 170). The insertion space 288 may be formed by each lead tabs 111, 112 is connected to the busbar assembly 150 (or the busbar 170).

Further, the insertion space 288 may include a plurality of separation spaces 2889 separated by the respective lead tabs 111, 112. It should be noted that each of the lead tabs 111, 112 does not isolate each of the plurality of separation spaces 2889, i.e., the length of each of the lead tabs 111, 112 along the height direction of the accommodating case 210 is less than the height of the accommodating space 280, and thus only separates at least a portion of the accommodating space 280 along its height.

That is, the length of each lead tabs 111, 112 along the height direction of the accommodating case 210 is less than the length of each main body portion 115, so that the plurality of separation spaces 2889 may be separated or may be connected to each other by each lead tabs 111, 112.

More specifically, a plurality of first insertion spaces 2881 may be formed by the first lead tab 111 and the plurality of first insertion spaces 2881 may be interconnected. Similarly, a plurality of second insertion spaces 2882 are formed by the second lead tab 112 and the plurality of second insertion spaces 2882 may be interconnected.

Thus, as described above, the plurality of separation spaces 2889 may be interconnected. Furthermore, the fire-retardant assembly 270 may also comprise a plurality of fire-retardant assemblies, each of which may be inserted into the each of the plurality of separation spaces 2889.

Referring now to FIG. 8, the battery assembly 200 may further comprise the thermal barrier member 119 positioned between the plurality of battery cells 110. Alternatively, the battery assembly 200 may further comprise a thermal barrier member 119 positioned between the battery groups BG grouping the plurality of battery cells 110.

Referring to FIG. 8, the thermal barrier member 119 may extend to the busbar assembly 150 in parallel with the plurality of battery cells 110. More specifically, the thermal barrier member 119 may extend to the busbar frames 151, 152 and be inserted into the busbar frames 151, 152. In this case, the fire-retardant assembly 270 may not be inserted into the space where the thermal barrier member 119 is inserted. This may prevent interference between the fire-retardant assembly 270 and the thermal barrier member 119.

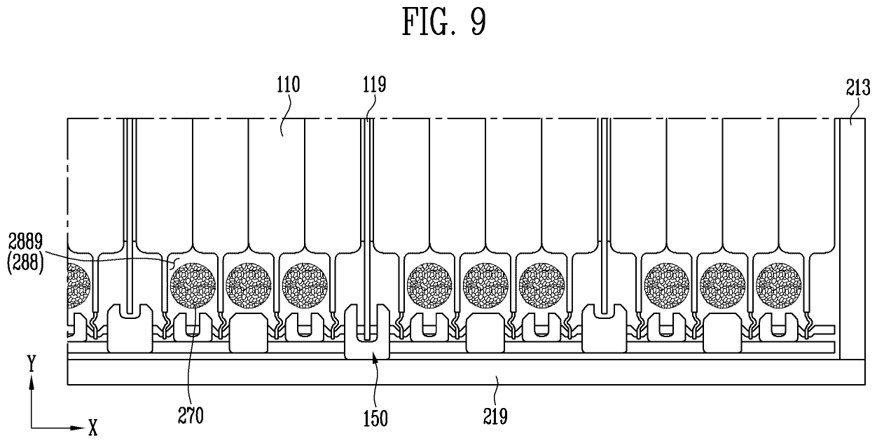

FIG. 9 is a cross-sectional view from above of an example of a battery assembly according to one embodiment of the present disclosure.

FIG. 9 illustrates a section viewed from above toward the accommodating body 219 (specifically, the region where the accommodating body 219 and either of the two endplates 212, 213 meet) after the accommodating cover 215 has been removed.

As described above, a plurality of vermiculite particles contained in the fire-retardant member 271 (or the fire-retardant material of the fire-retardant member 271 as a whole as described above) may be restrained in their movement by the exterior material 273, but at least some of the particles may be released from positional restraint by the exterior material 273 as the exterior material 273 melts.

Referring to FIG. 9, the insertion space 288 may be divided into a plurality of separation spaces 2889, and a plurality of fire-retardant assemblies 270 may be inserted into the separation spaces 2889 of at least some of the plurality of separation spaces 2889.

As described above, the battery assembly 200 may further comprise a thermal barrier member 119 positioned between the battery cells 110 along a stacking direction (e.g., X-direction) of the plurality of battery cells 110. In a direction perpendicular to the stacking direction in which the lead tabs 111, 112 protrude (e.g., in a Y direction), the thermal barrier member 119 may extend to connect with the busbar assembly 150, such that the plurality of separation spaces 2889 may not be filled with all of the fire-retardant assembly 270. Alternatively, however, in the absence of the thermal barrier member 119, each of the fire-retardant assemblies 270 may be inserted into all of the plurality of separation spaces 2889.

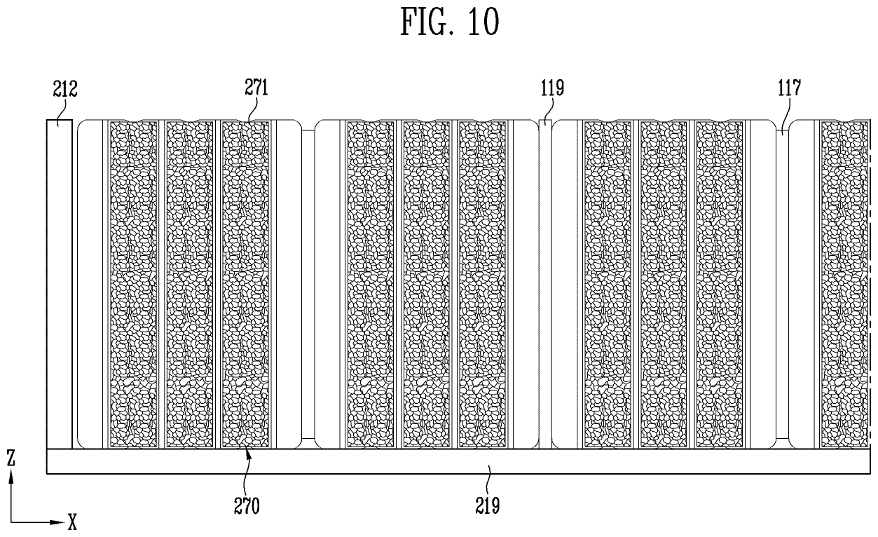

FIG. 10 is a side view of an example of a battery assembly according to one embodiment of the present disclosure.

FIG. 10 illustrates an area adjacent to either of the two endplates 212, 213 when viewing the battery assembly 200 after removal of the body sides 2191, 2192 and busbar assembly 150.

Referring now to FIGS. 4 through 10, the insertion space 288 may include a plurality of separation spaces 2889, and the fire-retardant assembly 270 may be located in a separation space 2889 of at least some of the plurality of separation spaces 2889. If the fire-retardant assembly 270 is capable of delaying thermal runaway of the battery cell 110, then the fire-retardant assembly 270 need not necessarily be located in each of the plurality of separation spaces 2889.

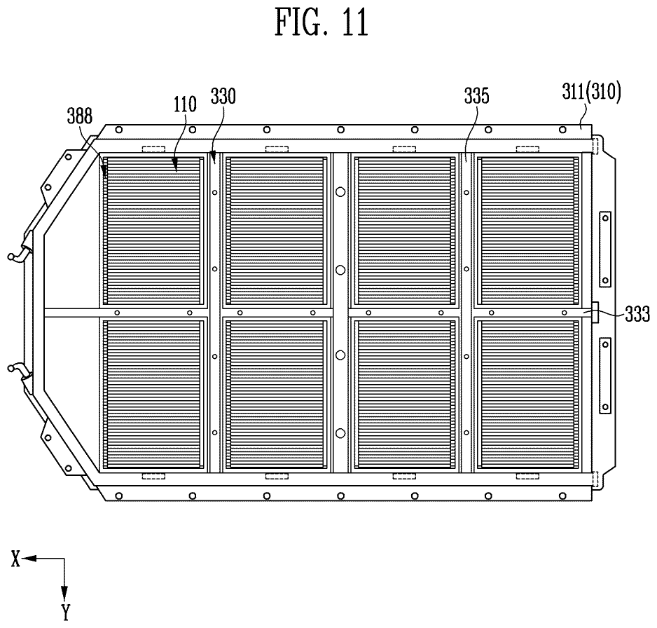

FIG. 11 is a diagram illustrating an example of a battery assembly in accordance with another embodiment of the present disclosure.

While the battery assembly 200 has been described above based on a battery module structure, FIG. 11 illustrates an alternative example of a battery assembly 300 that is configured in the form of a battery pack, i.e., the battery assembly 300 may be in the form of a cell to pack (CTP) structure that omits the battery module structure and instead accommodates a plurality of battery cells 110 in the form of a pack.

The battery assembly 300 may comprise a plurality of battery cells 110 stacked and arranged in a predetermined stacking direction, an accommodating case 310 accommodating the plurality of battery cells 110, an insertion space 388 formed between the plurality of battery cells 110 and the accommodating case 310 along the stacking direction, and a fire-retardant assembly (not shown) disposed in the insertion space 388.

The fire-retardant assembly may include a fire-retardant member and an exterior material accommodating the fire-retardant member therein. The configuration of the fire-retardant assembly, fire-retardant member, and exterior material is the same as previously described with reference to FIGS. 1 to 10, and therefore, redundant description will be omitted herein.

The accommodating case 310 may include a accommodating body 311 for accommodating the plurality of battery cells 110 and a accommodating cover (not shown) coupled to the accommodating body 311. Further, the accommodating case 310 may further include a compartment portion 330 that compartmentalizes the insertion space 388.

The compartment portion 330 may further comprise a first frame 333 and a second frame 335 that compartmentalize the plurality of battery cells 110 transversely and longitudinally, respectively. The first frame 333 and the second frame 335 may be configured to support and separate the plurality of battery cells 110, as well as to prevent deformation of the accommodating body 311.

Hereinafter, embodiments of the present disclosure will be further described with reference to specific experimental examples. The examples and comparative examples included in the experimental examples are merely illustrative of the embodiments of the present disclosure and are not intended to limit the scope of the appended claims. It will be apparent to those skilled in the art that various modifications and alterations to the embodiments can be made within the scope and technical concepts of the present disclosure, and it is natural that such modifications and alterations also fall within the scope of the appended claims. Furthermore, the embodiments can be combined to form additional embodiments.

### EXAMPLE

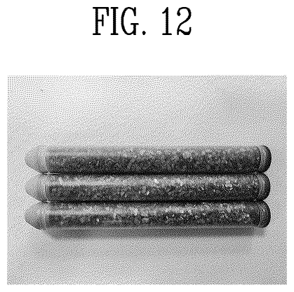

FIG. 12 is an image depicting a fire-retardant assembly manufactured in accordance with an Example.

### Example

Three fire-retardant assemblies filled with expanded vermiculite were prepared as shown in FIG. 12, within an exterior material having a cylindrical space formed inside.

### Comparative Example

Three fire-retardant assemblies were prepared that were manufactured identically to the fire-retardant assemblies of the embodiment except that silicon dioxide was filled instead of vermiculite.

### Evaluation Example

### (1) Gravimetric Evaluation

The weight of each of the three fire-retardant assemblies of the Example and the three fire-retardant assemblies of the Comparative Example was measured using a balance. The average weight of the three fire-retardant assemblies of the Example and the three fire-retardant assemblies of the Comparative Example calculated based on the weight of each measured fire-retardant assembly is shown in Table 1 below.

TABLE 1

| | Example | Comparative Example |
|---|---|---|
| Weight average value (g) | 4.0 | 8.3 |

As shown in Table 1 above, it can be seen that the fire-retardant assembly according to one aspect of the present disclosure weighs less than 50% of the same volume as the fire-retardant assembly of the comparative example. This is believed to be due to the fact that the vermiculite material has excellent fire retardancy (or heat resistance, flame retardancy), yet is light in weight compared to materials exhibiting similar fire retardancy.

### (2) Acoustic Measurement Evaluation

Three fire-retardant assemblies of the Example and three fire-retardant assemblies of the Comparative Example were each hand-shaken, and the noise generated by the hand-shaking was measured using a sound level meter. The average sound level of the three fire-retardant assemblies of the Example and the three fire-retardant assemblies of the Comparative Example, calculated based on the measured sound level of each fire-retardant assembly, are shown in Table 2 below.

TABLE 2

| | Example | Comparative Example |
|---|---|---|
| Average Noise (Hz) | 35 | 65 |

As shown in Table 2 above, it can be seen that the fire-retardant assembly according to one aspect of the present disclosure exhibits approximately 50% less noise caused by particle-to-particle collisions within the cavity during handshaking compared to the fire-retardant assembly of the comparative example. This is believed to be due to the fact that the vermiculite material has excellent fire retardancy (or heat resistance, flame retardancy), but also has a superior filling ratio compared to materials with similar fire retardancy.

### (3) Evaluation of Fire-retardant Performance

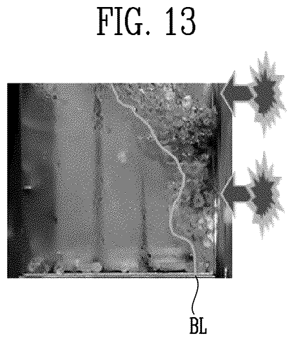

FIG. 13 is an image depicting the results of a fire delay performance evaluation using a fire-retardant assembly manufactured in accordance with an Example.

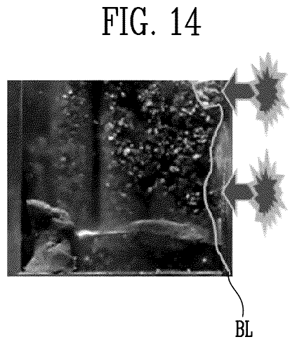

FIG. 14 is an image depicting the results of a fire delay performance evaluation using a fire-retardant assembly manufactured in accordance with a Comparative Example.

A fire delay test was conducted to evaluate the delay in fire propagation using a test jig that can simulate the environment within a battery assembly.

The test jig was constructed and designed to simulate the environment inside an actual battery assembly, and an insulating plate was attached to the inner surface of the jig to block heat flow through the jig and its surroundings. Within the jig, three fire-retardant assemblies of each of the Exemplary and Comparative Examples were placed side-by-side in an upright configuration based on a line connecting the top surface to the bottom surface inside the jig.

A flame with a temperature of approximately 900° C. was applied for 10 minutes using a butane gas torch (100 kPa) at a distance of 150 mm from one side of the test jig, and the boundary of the area where the flame finally transitioned BL is shown in FIGS. 13 and 14.

As shown in FIGS. 13 and 14, it was found that the fire-retardant assembly according to one aspect of the present disclosure has particularly good fire barrier and retardant performance compared to comparative examples. This is believed to be due to the fact that the vermiculite material has a fire-retardant performance equal to or better than that of other conventional fire-retardant materials, but can be more densely packed in the same volume of space, thereby more effectively blocking the flow of heat and maximizing fire retardant performance.

The above described are exemplary applications of the principles of the present disclosure, and other configurations may be included without departing from the scope of the present disclosure.

What is claimed is:

1. A fire-retardant assembly comprising:
a fire-retardant member comprising a fire-retardant material; and
an exterior material configured to accommodate the fire-retardant member therein,
wherein the fire-retardant material comprises a vermiculite.

2. The fire-retardant assembly according to claim 1, wherein the fire-retardant member comprises an expanded vermiculite.

3. The fire-retardant assembly according to claim 1, wherein the fire-retardant member comprises a plurality of vermiculite particles.

4. The fire-retardant assembly according to claim 3, wherein an average particle size of the plurality of vermiculite particles is more than or equal to 2 μm and less than or equal to 5 mm.

5. The fire-retardant assembly according to claim 1, wherein the exterior material starts to melt at a preset temperature, and the preset temperature is lower than a melting point of the fire-retardant member.

6. The fire-retardant assembly according to claim 1, wherein a filling rate of the fire-retardant member within the exterior material is from 90% to 99.9% by volume.

7. The fire-retardant assembly according to claim 1, wherein a weight of the fire-retardant assembly is from 3 g to 5 g.

8. A battery assembly comprising:
a plurality of battery cells that are stacked;
an accommodating case accommodating the plurality of battery cells;
an insertion space formed between the plurality of battery cells and the accommodating case; and
a fire-retardant assembly disposed in the insertion space,
wherein the fire-retardant assembly comprising:
a fire-retardant member comprising a fire-retardant material; and
an exterior material configured to accommodate the fire-retardant member therein,
wherein the fire-retardant material comprises a vermiculite.

9. The battery assembly according to claim 8, wherein the fire-retardant member comprises an expanded vermiculite.

10. The battery assembly according to claim 8, wherein the fire-retardant member comprises a plurality of vermiculite particles.

11. The battery assembly according to claim 10, wherein an average particle size of the plurality of vermiculite particles is more than or equal to 2 μm and less than or equal to 5 mm.

12. The battery assembly according to claim 8, wherein the exterior material starts to melt at a preset temperature, and the preset temperature is lower than a melting point of the fire-retardant member.

13. The battery assembly according to claim 8, wherein a filling rate of the fire-retardant member within the exterior material is from 90% to 99.9% by volume.

14. The battery assembly according to claim 8, wherein a weight of the fire-retardant assembly is from 3 g to 5 g.

15. The battery assembly according to claim 8, wherein a height of the exterior material is greater than a maximum length of one end face of the exterior material in a direction perpendicular to the height of the exterior material.

16. The battery assembly according to claim 8, wherein the exterior material has a cylindrical or polyhedral shape.

17. The battery assembly according to claim 8, further comprising a busbar electrically connected to the plurality of battery cells,
wherein the insertion space is located between the busbar and the plurality of battery cells.

18. The battery assembly according to claim 8, wherein the insertion space comprises:
a first insertion space formed between the plurality of battery cells and a one side of the accommodating case extending along a stacking direction of the plurality of battery cells; and
a second insertion space formed between the plurality of battery cells and the other side of the accommodating case facing the one side of the accommodating case;
wherein the fire-retardant assembly is disposed in at least one of the first insertion space and the second insertion space.
